(19) United States
(12) Patent Application Publication
(10) Pub. No.: US 2009/0153707 A1
(43) Pub. Date: Jun. 18, 2009

(54) Solid-state image pickup device and electronic device comprising the same

(75) Inventor: Yoshihiro Nakao, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/316,394

(22) Filed: Dec. 12, 2008

(30) Foreign Application Priority Data
Dec. 13, 2007 (JP) 2007-322499

(51) Int. Cl. H04N 5/335

(52) U.S. Cl. 348/294; 348/E05.091

(57) ABSTRACT

A camera module 100 comprises at the bottom of a lens unit 4, a flange unit 43 being extended beyond a contact portion C between the lens unit 4 and a lens holder 3. Debris D produced by contact between the lens holder 3 and the lens unit 4 is collected on the flange unit 43. This can prevent poor imaging caused by the debris D. Therefore, it is possible to provide a simply-configured camera module 100 in which poor imaging due to debris is prevented but miniaturization is not hindered.

This Nonprovisional application claims priority under U.S.C. §119(a) on Patent Application No. 322499/2007 filed in Japan on Dec. 13, 2007, the entire contents of which are hereby incorporated by reference.

### FIELD OF THE INVENTION

The present invention relates to a solid-state image pickup device preventing debris from being attached to an optical path, and to an electronic device comprising the same.

### BACKGROUND OF THE INVENTION

An electronic device, such as a camera-equipped mobile phone (portable terminal) comprises a camera module (solid-state image pickup device). FIG. 5 is a cross-sectional view of a camera module. As illustrated in FIG. 5, a camera module 200 includes a solid-state image sensor 202 and a DSP 205 on a circuit board 201. The solid-state image sensor 202 is formed from a semiconductor image sensor, such as a CCD, a CMOS, or the like. The DSP 205 has a function of processing image data outputted from the solid-state image sensor 202. Furthermore, on the circuit board 201, a lens holder 203 wherein the solid-state image sensor 202 is stored is mounted. Inside the lens holder 203, a lens unit 204 with an optical lens 214 for imaging in a light-receiving area of the solid-state image sensor 202 combined is held. Furthermore, the lens holder 203 is provided with a glass 206 on a surface facing the solid-state image sensor 202.

In assembling such camera module 200, it is necessary to adjust a position of a lens of the lens unit 204 so as to adjust a focus. The lens unit 203 and the lens unit 204 (FIG. 5 dashed part) are threaded at a contact portion C. That is, an inside surface of the lens holder 203 and an outside surface of the lens unit 204 screw with each other. This enables adjustment of the focus by moving the lens unit 204 up and down along the inside surface of the lens holder 203.

However, moving the lens unit 204 up and down creates friction between the lens holder 203 and the lens unit 204. The friction produces fine debris (foreign materials) D. This debris (foreign materials) D is classified into (i) foreign materials that are originally attached to the lens holder 203, (ii) the lens holder 203 itself (a part of the lens holder 203 scraped off), and (iii) the like.

In the camera module 200, when such debris D drops off, the debris would stay on an optical path (for example, on the glass 206). The debris on the glass 206 casts a shadow on the solid-state image sensor 202, and is reflected on an output image as a black spot or stain. This will lead to decreases in yields and reliability of the camera module 200. That is, the debris D on the optical path can cause poor imaging.

To solve this problem, Patent Document 1 discloses a camera module preventing debris from dropping off on an optical path. FIG. 6 is a cross-sectional view of a camera module 300 of Patent Document 1. The camera module 300 comprising a characteristic lens holder 303 is significantly different from the camera module 200 in terms of the condition of contact between the lens holder 303 and a lens unit 304. That is, in the camera module 300, the lens holder 303 comprises a cylindrical unit 303a whose periphery (outside surface) abuts the lens unit 304, as illustrated with a dashed line in FIG. 6. Specifically, the cylindrical unit 303a of the lens holder 303 is inserted into a race 304a, which is formed in the lens unit 304. As a result, debris D produced at a contact portion C between the lens unit 303 and the lens unit 304 is allowed to escape to the outside of the lens holder 303. Therefore, it is possible to prevent the debris D from entering an optical path (e.g. a glass 306).

However, with the configuration disclosed in Patent Document 1, there is a problem that a form of a lens unit will be complicated and also cannot cope with miniaturization of a solid-state image pickup device.

Specifically, in FIG. 6 camera module 300, it is necessary to make a side surface of the lens unit 304 double-structured so as to form a race 304a. For this reason, a form of the lens unit 304 is to be complicated. As a result, it is difficult to form the lens unit 304 by metal molding.

Furthermore, if a configuration is such that a side surface of the lens unit 304 is made double-structured and the lens unit 304 contacts an outside surface of the lens holder 303 (cylindrical part 303a), the size of the lens unit 304 will be larger than that of the lens holder 303. For this reason, such configuration cannot cope with accelerating miniaturization of a solid-state image pickup device.

[Patent Document 1] Japanese Unexamined Patent Application, Tokukai, Publication No. 2005-208377 (Published on Aug. 4, 2005)

### SUMMARY OF THE INVENTION

Therefore, the present invention is made in consideration of the aforementioned problems. It is an object of the present invention to provide a simply-configured solid-state image pickup device in which poor imaging due to debris is prevented but miniaturization is not hindered, and an electronic device comprising the same.

In order to attain the object, a solid-state image pickup device comprises a lens unit forming a subject image, a solid-state image sensor converting into an electric signal the subject image formed by the lens unit, a lens holder holding the lens unit inside and storing the solid-state image sensor inside, wherein an outside surface of the lens unit and an inside surface of the lens holder contact with each other in such a manner that the lens unit is movable along the inside surface of the lens holder, and the lens unit having a flange unit at its bottom, the flange unit being extended beyond a contact portion where the lens unit and the lens holder contact with each other.

According to the present invention, the flange unit is formed at the bottom of the lens unit. The flange unit is a part extended beyond a contact portion between the lens unit and the lens holder. That is, the flange unit is distant from an optical path. This allows debris produced by a contact between the lens unit and the lens holder to be collected on the flange unit distant from the optical path (or on a surface of the flange unit facing the lens holder). That is, it is possible to prevent the debris from entering the optical path and thus poor imaging due to the debris can be prevented.

Furthermore, according to the present invention, the outside surface of the lens unit and the inside surface of the lens holder contact with each other. For this reason, a form of the lens unit is less complicated than that in the solid-state image pickup device disclosed in Patent Document 1. Therefore, the lens unit can have a simple configuration for taking measures against debris.

Moreover, according to the present invention, the lens unit is held inside the lens holder. For this reason, a size of the lens unit will not be larger than that of the lens holder and thus miniaturization of a solid-state image pickup device will not be prevented, either.

In this way, according to the present invention, it is possible to provide a solid-state image pickup device wherein a simply-configured lens unit prevents poor imaging due to debris but does not hinder miniaturization.

Furthermore, “the lens unit can move along the inside surface of the lens holder” shows not only the movement of the lens unit in a fixed-focus solid-state image pickup device for adjusting the focus but also that in a solid-state image pickup device with functions, such as automatic focusing, macro, and the like in which a focal length changes.

Moreover, in order to attain the aforementioned object, an electronic device of the present invention comprises a solid-state image pickup device comprising a lens unit forming a subject image, a solid-state image sensor converting into an electric signal the subject image formed by the lens unit, a lens holder holding the lens unit inside and storing the solid-state image sensor inside, wherein an outside surface of the lens unit and an inside surface of the lens holder contact with each other in such a manner that the lens unit is movable along the inside surface of the lens holder, and the lens unit having a flange unit at its bottom, the flange unit being extended beyond a contact portion where the lens unit and the lens holder contact with each other. Therefore, it is possible to provide an electronic device wherein a simply-configured lens unit prevents poor imaging caused by debris but does not hinder miniaturization.

Additional objects, features, and strengths of the present invention will be made clear by the description below. Furthermore, the advantages of the present invention will be evident from the following explanation in reference to the drawings.

### BRIEF DESCRIPTION OF THE DRAWINGS

FIG. 1 is a cross-sectional view of a camera module of the present invention.

FIG. 2 is a cross-sectional view of a lens unit of FIG. 1 camera module.

FIG. 3 is a cross-sectional view of another lens unit of FIG. 1 camera module.

FIG. 4 is a cross-sectional view of another camera module of the present invention.

FIG. 5 is a cross-sectional view of the existing camera module.

FIG. 6 is a cross-sectional view of the camera module disclosed in Patent Document 1.

### DESCRIPTION OF THE EMBODIMENTS

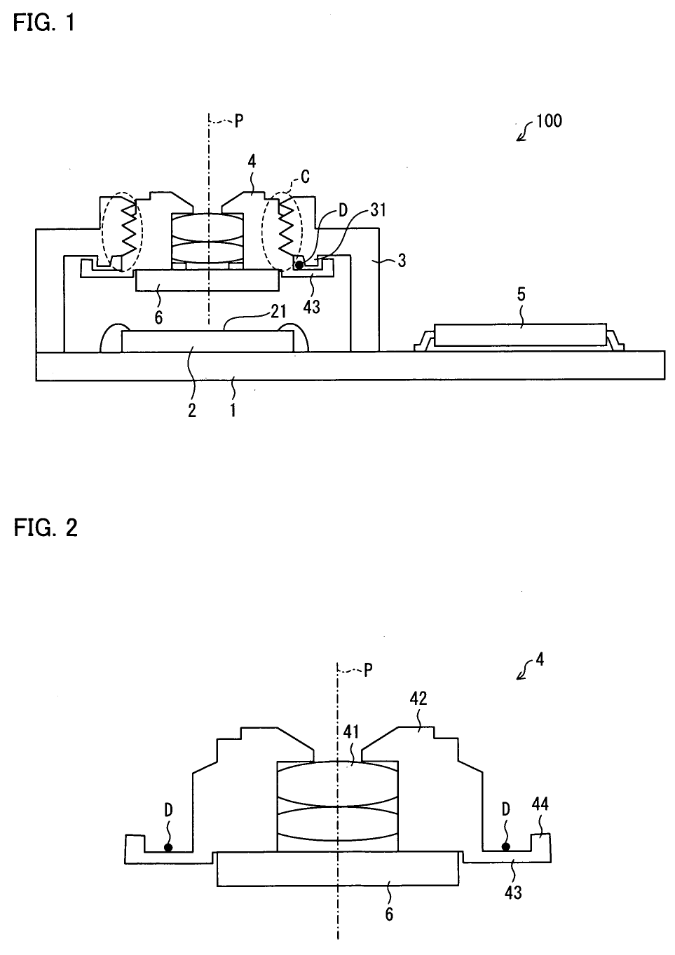

The following is a description of one embodiment of the present invention based on FIGS. 1 to 4.

A solid-state image pickup device of the present invention is configured such that poor imaging is reduced by collecting debris at a bottom of a lens unit and preventing the debris from being attached to an optical path.

The solid-state image pickup device of the present invention is suitable for electronic devices with the function of imaging, such as camera-equipped mobile phones, digital still cameras, security cameras, and the like. In the present embodiment, a camera module (solid-state image pickup device) applicable to a camera-equipped mobile phone is to be described.

FIG. 1 is a cross-sectional view of a camera module 100 of the present embodiment. As illustrated in FIG. 1, the camera module 100 comprises a solid-state image sensor 2 and a DSP 5 mounted on a circuit board 1 as well as a lens holder 3 storing the solid-state image sensor 2 inside and holding a lens unit 4 inside. Furthermore, on a backside of the lens unit 4, a transparent member 6 is provided. Moreover, for simple description, the circuit board 1 side (the side approaching the circuit board 1) and the transparent member 6 side (the side distant from the circuit board 1) are to be designated as a lower side and an upper side respectively.

Specifically, the circuit board 1 is a board to pick up an electric signal of the solid-state image sensor 2. The circuit board 1 includes a patterned wiring thereon (not illustrated). This wiring electrically connects the circuit board 1 to the solid-state image sensor 2 positioned at a center portion of the circuit board 1. The wiring and the solid-state image sensor 2 are connected by a bonding wiring. This enables interactive transmission of electric signals therebetween. The circuit board 1 is, for example, a printed board, a glass epoxy board, or a ceramic board. Furthermore, the circuit board 1 can be electrically connected to an external apparatus.

The solid-state image sensor 2, which is positioned at the center portion of the circuit board 1, is configured such that a semiconductor board where a semiconductor circuit is provided (e.g. silicon single crystal board) is formed rectangularly in plan view. The solid-state image sensor 2 may be, for example, a CCD (charge-coupled device) image sensor, a CMOS (complementary metal-oxide semiconductor) image sensor, or a VMIS image sensor (Threshold Voltage Modulation Image Sensor). The solid-state image sensor 2 converts a subject image formed at the lens unit 4 into an electric signal, or serves as a sensor device photoelectrically converting incident light entered from the lens unit 4.

On a surface (top) of the solid-state image sensor 2, a light-receiving unit 21 where several pixels are arranged like a matrix is formed. The light-receiving unit 21 is an effective pixel area (imaging surface) of the solid-state image sensor 2. The solid-state image sensor 2 converts a subject image formed at the light-receiving unit 21 (light transmitted through the transparent member 6) into an electric signal and outputs the signal as an analogue image signal.

A DSP (digital signal processor) 5 is a signal processing circuit where such signal processing of the solid-state image sensor 2 is done. The DSP 5 controls operations of the solid-state image sensor 2. The DSP 5 functions as a control unit (image processing apparatus) which appropriately controls the operations of the solid-state image sensor 2 and appropriately processes signals (image data) outputted from the solid state image sensor 2, thereby to generate required signals. For example, the DSP 5 processes unprocessed image data outputted from the solid-state image sensor 2 into image data required by users by doing processing of color tone adjustment, and the like and outputs the processed image data to the outside.

Furthermore, the circuit board 1 may be provided with various electronic components (not illustrated) for driving the camera module 100, such as an amplifier circuit unit (analogue signal circuit unit), an analogue/digital conversion processing circuit unit, a CPU, a ROM, a RAM, and the like. The amplifier circuit unit (analogue signal circuit unit) amplifies and processes an electric signal converted by a light-receiving sensor of the light-receiving unit 21 and outputs the electric signal as an analogue signal. The analogue/digital conversion processing circuit unit converts the analogue signal into a digital one. The CPU performs a variety of arithmetic processing according to a program. The ROM stores the program therein. The RAM temporally stores data during the processing therein. The whole camera module 100 is controlled by these components.

The lens holder 3, attached to a top of the circuit board 1 with an adhesive (not illustrated), stores the solid-state image sensor 2 inside and holds the lens unit 4 inside. Inside the lens holder 3, the solid-state image sensor 2 is stored (sealed) on a lower side and the lens unit 4 is held on an upper side. In the present embodiment, the lens holder 3 is a tubular member made of resin.

The lens unit 4 is an imaging optical system for forming a subject image. That is, the lens unit 4 is an optical system for forming, at the solid-state image sensor 2, an image from light coming from a subject. In the camera module 100, the lens unit 4 is held inside the lens holder 3. For this reason, a size of the lens unit 4 cannot be larger than that of the lens holder 3. Therefore, miniaturization of the camera module 100 will not be hindered.

In the camera module 100, as illustrated in FIG. 1, the outside surface of the lens unit 4 and the inside surface of the lens holder 3 contact with each other. (a contact portion C illustrated with a dashed line in FIG. 1) For this reason, threading is done on the outside surface of the lens unit 4 and the inside surface of the lens holder 3 respectively. As a result, it is possible to rotate and move the lens unit 4 toward an optical path P (optical axis) along the inside surface of the lens holder 3. This enables adjustment of a distance between the solid-state image sensor 2 and the lens unit 4 so as to adjust the focus. When the lens unit 4 is moved, debris D is produced from the threading area, which is the junction of the lens holder 3 with the lens unit 4. The debris D can cause poor imaging. In the camera module 100, measures to prevent the debris D which can cause poor imaging from entering are taken in the lens unit 4. A specific configuration of the lens unit 4 is to be described later.

Moreover, a method of moving the lens unit 4 in the present embodiment is by a threading structure, which may be an electric-powered method using electromagnets.

The transparent member 6 is held on the backside of the lens unit 4 (a surface facing the solid-state image sensor 2). The transparent member 6 is provided between the lens unit 4 and the solid-state image sensor 2 and held by the lens holder 3. The transparent member 6 at least covers the light-receiving unit 21 of the solid-state image sensor 2 and is formed from a transparent member, such as glass, resin, or the like with transparency. Furthermore, on the transparent member 6, an optical filter, such as an infrared cut filter cutting infrared rays incident to the solid-state image sensor 2 may be formed. This enables the transparent member 6 to be provided with a function of cutting infrared rays from the outside.

In such a camera module 100, light captured from the outside through the lens unit 4 is taken inside the solid-state image sensor 2 through the transparent member 6. The light is received as an image by the light-receiving sensor provided at the light-receiving unit 21 of the solid-state image sensor 2.

Moreover, in FIG. 1, the DSP 5 formed on the circuit board 1 is not stored in the lens holder 3. However, a configuration is not limited to that illustrated in FIG. 1, but the DSP 5 may be stored in the lens holder 3. Furthermore, the solid-state image sensor 2 may be provided on the DSP 5. That is, in the camera module 100, the DSP 5 may be built in the lens holder 3 or the solid-state image sensor 2 and the DSP 5 may be constituted by one chip (a stack structure where the solid-state image sensor 2 is provided on the DSP 5 is also possible).

Here a characteristic part of the camera module 100 is to be described. In the camera module 100, a shadow of the fine debris D on the optical path P (the path from the lens 4, the transparent member 6 to the solid-state image sensor 2 (the light-receiving unit 21)) is formed on an image as a black spot or stain. As a result, poor imaging is caused. So the camera module 100 is configured so that the debris D produced from the contact portion C between the lens holder 3 and the lens unit 4 will be collected at the bottom of the lens unit 4. FIG. 2 is a cross-sectional view of the lens unit 4.

As illustrated in FIG. 2, the lens unit 4 comprises plural (two in the present embodiment) lenses 41 and a lens barrel 42 (lens tube) holding the lenses 41 at a center portion. Both the lens 41 and the lens barrel 42 can be made of resin, for example. An optical axis of the lens 41 coincides with that of the lens barrel 42.

The lens barrel 42 has a side surface on which the lens barrel 42 contacts with the lens holder 3. The side surface is threaded. In the lens barrel 42, a flange unit 43 is formed at the bottom. The flange unit 43 is extended beyond a contact portion between the lens barrel 42 and the lens holder 3. That is, the flange unit 43 is a part extended away from the optical path P. With this configuration, the debris D produced by the lens unit 4 and the lens holder 3 contacting with each other can be collected on the flange unit 43 positioned off the optical path P (or on a surface of the flange unit 43 facing the lens holder 3). That is, it is possible to prevent the debris D from entering the optical path P and thus to prevent poor imaging due to the debris D. In this way, in the camera module 100, the lens barrel 42 whose shape is like a sword guard (flange), is configured so as to catch foreign materials, including the debris D.

Furthermore, the camera module 100 is configured such that the outside surface of the lens unit 4 and the inside surface of the lens holder 3 contact with each other. For this reason, a form of the lens unit is not so complicated as that of the solid-state image pickup device disclosed in Patent Document 1. That is, it is not necessary to make the lens unit double-structured. Therefore, in the camera module 100, the lens unit 4 can have a simple configuration for taking measures against debris.

In FIG. 2, the flange unit 43 is extended in a perpendicular direction to the optical path P (parallel with a light-receiving surface of the solid-state image sensor 2). The form of the flange unit 43 is not limited to this, provided that the flange unit 43 is extended in a direction away from the optical path P. It is preferable that the flange unit 43 be extended to the outside of the solid-state image sensor 2 (beyond the solid-state image sensor 2). This prevents the debris D from being attached to the solid-state image sensor 2 (especially to the light-receiving unit 21) even if the debris D drops off from the edge of the flange unit 43. Moreover, for example, the flange unit 43 may be extended inclining toward the lens 41 (above).

Furthermore, in FIG. 2, it is preferable that the flange unit 43 have a projection 44 protruding toward the lens holder 3 on a surface facing the lens holder 3. A site where the projection 44 is formed is not particularly limited as long as it is on the surface facing the lens holder 3. Moreover, the number of the projections 44 is not limited, either.

If the projection 44 is formed in this way on the surface of the flange unit 43 where the debris D is collected (on the transfer pathway of the debris D), the transfer pathway of the debris D is complicated in shape. Therefore, it is possible to prevent the debris D collected on the flange unit 43 from dropping off from the flange unit 43. That is, the projection 44 formed on the flange unit 43 functions as a weir (wall) for preventing the debris D from dropping off from the flange unit 43.

Furthermore, in FIG. 2, the projection 44 is formed on the edge portion (throughout the circumference) of the flange unit 43. That is, a saucer structure to catch the debris D is formed by the flange unit 43. This can prevent the debris D from dropping just before the debris drops off from the flange unit 43 and also make the capture of the debris D on the flange unit 43 more effective.

Moreover, in the camera module 100 of the present embodiment, as illustrated in FIG. 1, the lens holder 3 has a protruding part 31 projecting toward the flange unit 43 on a surface facing the flange unit 43. That is, in the lens holder 3, the protruding part 31 is formed toward the transfer pathway of the debris D. This complicates the shape of the transfer pathway of the debris D as in the case of forming the projection 44 in the lens unit 4. Therefore, it is possible to prevent the debris D collected on the flange unit 43 from dropping off from the flange unit 43.

Furthermore, as illustrated in FIG. 1 and FIG. 2, the camera module 100 of the present embodiment is provided with the transparent member 6 at the backside (bottom) of the flange unit 43 so as to cover the light-receiving unit 21 of the solid-state image sensor 2. With this configuration, since the transparent member 6 is directly attached to the backside of the flange unit 43, a pathway of the debris D entering a surface (top) of the transparent member 6 will be cut off. Therefore, it is possible to prevent the debris D from being attached to the surface of the transparent member 6.

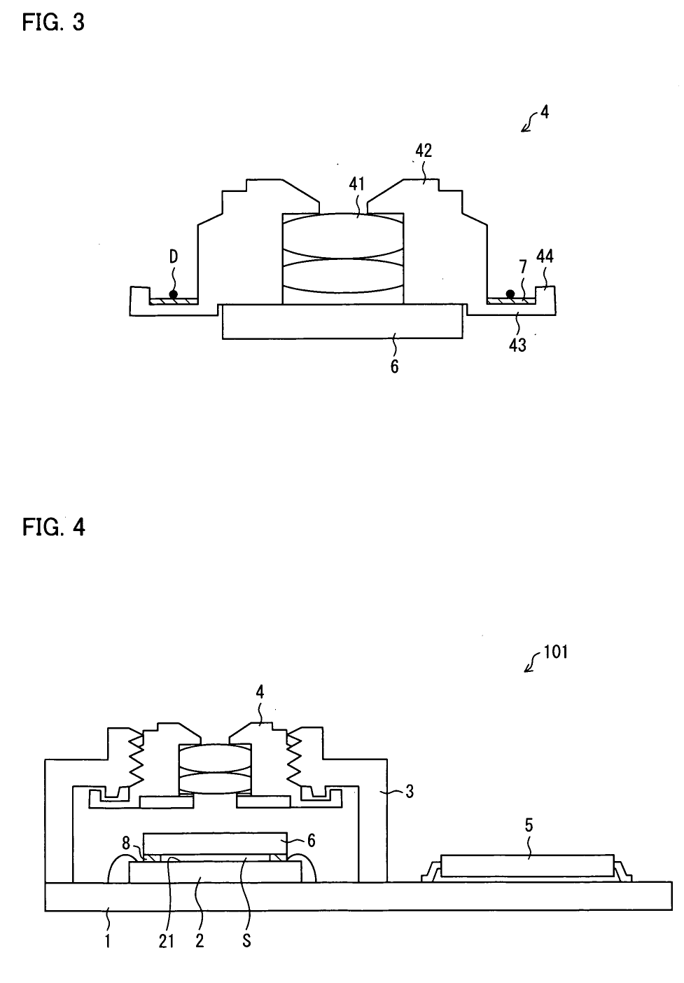

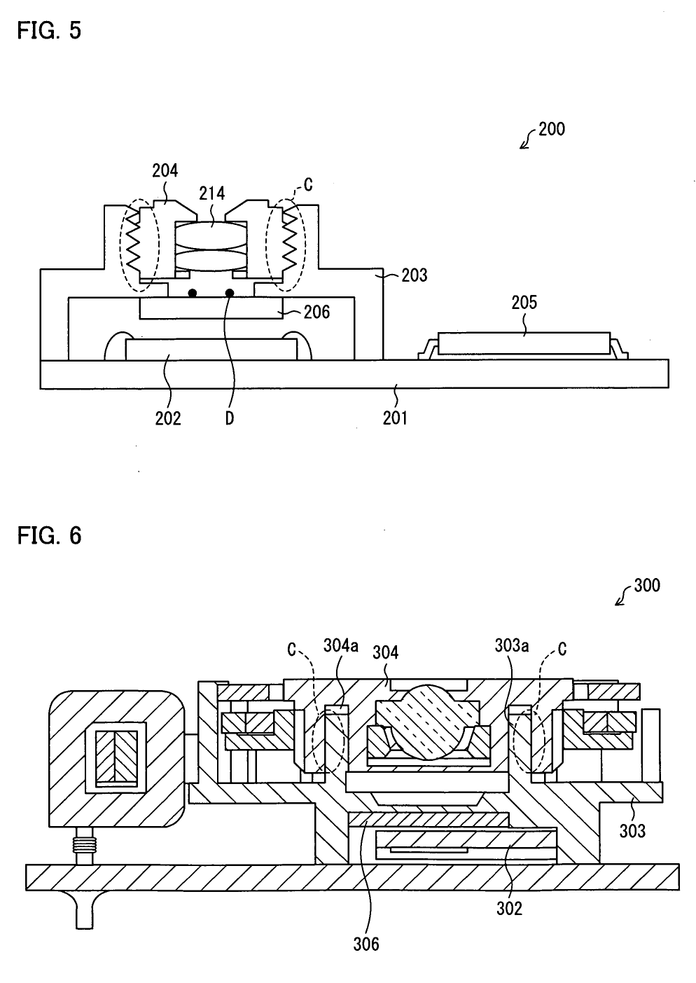

On the other hand, the lens unit 4 may be configured as illustrated in FIG. 3. FIG. 3 is a sectional view illustrating another configuration of the lens unit 4. In FIG. 3 lens unit 4, an adhesive 7 is applied on a surface facing the lens holder 3, or on a surface of the flange unit 43 where the debris D is collected. This allows the debris D collected on the flange unit 43 to be attached to the adhesive 7. For this reason, the debris D can be collected securely on the flange unit 43. This provides long-term prevention of poor imaging caused by debris, and also securely prevents the debris D from entering the solid-state image sensor 2. Moreover, also in this case, it is possible to make the capture of the debris D on the flange unit 43 more effective.

The adhesive 7 may be, but not limited to, a semi-solid-state (or nearly solid-state) fat (oil) or resin. Grease is suitable, for example. Grease, which is one of the fats and oils in a semi-solid state or close to liquid, can be formed from a lubricator in a semi-solid state (or nearly solid state) or in a paste form, for example. For grease, for example, it is possible to use molybdenum disulfide-series lubricator, white-series lubricator, silicone-series lubricator, perfluoropolyether-series lubricator, or the like, or mineral oil-series grease formed mainly from mineral oil, poly α-olefin-series grease formed mainly from poly α-olefin oil, silicone-series grease formed mainly from silicone oil, fluorosilicone-series grease, perfluoropolyether-series grease formed mainly from perfluoropolyether, or the like. These kinds of grease can be used separately or with 2 or more kinds mixed. Furthermore, grease may contain an additive for grease, such as lithium soap, calcium soap, polytetrafluoroethylene (PTFE), or the like.

Moreover, even if too much adhesive 7 is applied on the flange unit 43, the projection 44 functions as a weir. For this reason, the adhesive 7 does not leak from the flange unit 43.

The adhesive 7 is not particularly limited in terms of its quantity to be applied, provided that the adhesive 7 in the quantity can adhere the debris D thereto. The quantity of the adhesive 7 may be set according to properties of the adhesive 7. Furthermore, a rather larger quantity of the adhesive 7 may be applied on a part where the debris D is easy to be produced.

Moreover, using grease as the adhesive 7 also brings the following effects.
(a) Grease can not only attach the debris D but also coat (spread) the debris D attached to a position to be applied before grease is applied.
(b) It is easy to spread grease over an area to be applied since grease has fluidity.
(c) Grease is highly durable (e.g. physicality, such as heat resistance, weatherability, and the like).
(d) Grease is nontoxic.
(e) It is possible to easily alter the properties of grease (for example, to control viscosity) by changing a composition of grease.
(f) Grease requires no maintenance.

Furthermore, the camera module 100 can also be configured as illustrated in FIG. 4. FIG. 4 is a cross-sectional view of another camera module (solid-state image pickup device) 101 of the present invention. The camera module 101 is provided with the transparent member 6 on the solid-state image sensor 2. The transparent member 6 covers the light-receiving unit 21 of the solid-state image sensor 2. The transparent member 6 is provided with a gap S between itself and the light-receiving unit 21.

Specifically, in the camera module 101, the transparent member 6 is provided on a surface where the light-receiving unit 21 of the solid-state image sensor 2 is formed. The transparent member 6 faces the light-receiving unit 21. That is, the transparent member 6 is provided so as to cover the light-receiving unit 21. The transparent member 6 is attached on the solid-state image sensor 2 via an adhesion part 8 formed on the periphery of the light-receiving unit 21. The transparent member 6 is provided so that a gap (space) S will be formed between itself and the light-receiving unit 21. Since the adhesion part 8 is formed throughout the periphery of the light-receiving unit 21, this gap S is a sealed space. This can prevent entry of moisture and penetration and attachment of dust as well as production of defectives at the light-receiving unit 21.

Moreover, the adhesion part 8 is, for example, formed with patterning done by pasting a sheet adhesive and doing processing, such as exposure, development, and the like with photolithography technique. In this way, with the photolithography technique, it is possible to do patterning of the adhesion part 8 highly accurately. Furthermore, with a sheet adhesive, it is possible to make the thickness of the adhesion part 8 uniform. This enables highly-accurate adhesion of the transparent member 6 to the light-receiving unit 21.

In the camera module 101, since a gap between the light-receiving unit 21 and the transparent member 6 is hollow, light transmitted through the transparent member 6 directly enters the light-receiving unit 21, and thus there is no light loss caused through the optical path.

Such a camera module 101 can also bring the same effect as the camera module 100. Moreover, in the camera module 101, the light-receiving unit 21 of the solid-state image sensor 2 is covered by the transparent member 6. For this reason, the light-receiving unit 21 of the solid-state image sensor 2 is not exposed, which can prevent debris from entering the light-receiving unit 21 of the solid-state image sensor 2.

The camera module 100/101 can be produced by incorporating the lens unit 4 with the lens holder 3 from the lower side of the lens holder 3 first and then adhering the lens holder 3 to the circuit board 1 by curing. On the other hand, the existing camera module can be produced by (i) adhering a lens holder to a circuit board by curing, (ii) incorporating a lens barrel from an upper side of the lens holder, and then (iii) adjusting the focus. For this reason, the method for producing the camera module 100/101 of the present embodiment, which is different from the existing production method in terms of the order of processes, makes it comparatively easier to produce a camera module than the existing production method.

As set forth above, according to the camera module 100/101, the flange unit 43 formed at the bottom of the lens unit 4 enables the debris D which can cause poor imaging to be collected on the flange unit 43. Therefore, it is possible to provide a camera module wherein a simply-configured lens unit prevents poor imaging due to debris but does not prevent miniaturization. Furthermore, it is possible to provide a portable device (electronic device) with reliability improved by using such camera module.

Moreover, the camera module 100/101 is a fixed focus-type solid-state image pickup device wherein a distance between the solid-state image sensor 2 and the lens unit 4 (so-called focal length) is schematically fixed and measures against debris produced when this focal length is fine-adjusted by moving the lens unit 4 along the inside surface of the lens holder 3 for adjusting the focus were described. However, not only in adjusting the focus but also in activating functions of automatic focusing, zooming and macro, the lens unit 4 moves along the inside surface of the lens holder 3. For this reason, the debris D is produced also in activating such functions. It is also possible to collect the debris D produced in such case on the flange unit 43.

That is, the configuration of the lens unit 4 can be applied not only to a fixed focus-type solid-state image pickup device where a focal length is fixed but also to a variable focus-type solid-state image pickup device where a focal length changes.

As set forth above, a solid-state image pickup device of the present invention is configured such that a lens unit has a flange unit at its bottom, the flange unit being extended beyond a contact portion where the lens unit and the lens holder contact with each other. Therefore, it is possible to provide a solid-state image pickup device wherein a simply-configured lens unit prevents poor imaging caused by debris but does not hinder miniaturization.

In the solid-state image pickup device of the present invention, it is preferable that the flange unit have a projection on a surface facing the lens holder and the projection protrude toward the lens holder.

According to the present invention, the flange unit comprises the projection protruding toward the lens holder on the surface facing the lens holder where debris is collected. The surface facing the lens holder of the flange unit is a transfer pathway of the debris, on which the projection is formed. This makes a form of the transfer pathway of the debris complicated, which can prevent the debris collected on the flange unit from dropping off from the flange unit. That is, the projection formed on the flange unit functions as a weir for preventing the debris from dropping off from the flange unit.

In the present prevention, it is preferable that the projection be formed on an edge portion of the flange unit.

According to the present invention, the projection is formed on the edge portion (circumference) of the flange unit. This can prevent the debris from dropping off just before the debris drops off from the flange unit.

In the solid-state image pickup device of the present invention, it is preferable that the flange unit have a surface facing the lens holder, on which surface an adhesive is applied.

According to the present invention, the adhesive is applied on a surface of the flange unit where debris is collected. This allows the debris collected on the flange unit to be attached to the adhesive. For this reason, the debris can be collected securely on the flange unit. Therefore, it is possible to prevent, for a long term, poor imaging caused by debris.

In the solid-state image pickup device, it is preferable that the lens holder have a protruding part on a surface facing the flange unit, the protruding part projecting toward the flange unit.

According to the present invention, the lens holder has the protruding part projecting toward the flange unit on the surface facing the flange unit. That is, in the lens holder, the protruding part is formed toward a transfer pathway of the debris. This makes the form of the transfer pathway of the debris complicated as in the case of forming the projection in the lens unit. Therefore, it is possible to prevent the debris collected on the flange unit from dropping off from the flange unit.

The solid-state image pickup device of the present invention may be configured to comprise a transparent member on a backside of the flange unit so as to cover the light-receiving unit of the solid-state image sensor.

According to the present invention, the transparent member is provided on the backside of the flange unit. This can prevent the debris from being attached to the transparent member.

The solid-state image pickup device of the present invention may be configured to comprise a transparent member on the solid-state image sensor so as to cover the light-receiving unit of the solid-state image sensor with a gap between the transparent member and the light-receiving unit.

According to the present invention, the light-receiving unit of the solid-state image sensor is covered by the transparent member. This prevents the light-receiving unit of the solid-state image sensor from being exposed. Therefore, it is possible to prevent debris from entering the light-receiving unit of the solid-state image sensor.

In order to solve the aforementioned problems, an electronic device of the present invention comprises a solid-state image pickup device, the solid-state image pickup device comprising a lens unit forming a subject image, a solid-state image sensor converting into an electric signal the subject image formed by the lens unit, a lens holder holding the lens unit inside and storing the solid-state image sensor inside, wherein an outside surface of the lens unit and an inside surface of the lens holder contact with each other in such a manner that the lens unit is movable along the inside surface of the lens holder, and the lens unit having a flange unit at its bottom, the flange unit being extended beyond a contact portion where the lens unit and the lens holder contact with each other. Therefore, it is possible to provide an electronic device wherein a simply-configured lens unit prevents poor imaging caused by debris but does not hinder miniaturization.

The present invention can be applied to various image pickup devices comprising a solid-state image pickup device, such as camera-equipped mobile phones, digital still cameras and security cameras for surveillance and intercoms.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the aforementioned detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A solid-state image pickup device comprising:
a lens unit forming a subject image,
a solid-state image sensor converting into an electric signal the subject image formed by said lens unit,
a lens holder holding said lens unit inside and storing said solid-state image sensor inside, wherein:
an outside surface of said lens unit and an inside surface of said lens holder contact with each other in such a manner that said lens unit is movable along the inside surface of said lens holder,
said lens unit having a flange unit at its bottom, the flange unit being extended beyond a contact portion where said lens unit and said lens holder contact with each other.

2. The solid-state image pickup device as set forth in claim 1 wherein said flange unit has a projection on a surface facing said lens holder, the projection protruding toward said lens holder.

3. The solid-state image pickup device as set forth in claim 2 wherein said projection is on an edge portion of said flange unit.

4. The solid-state image pickup device as set forth in claim 1 wherein said flange unit has a surface facing said lens holder, on which surface an adhesive is applied.

5. The solid-state image pickup device as set forth in claim 1 wherein said lens holder has a protruding part on a surface facing said flange unit, the protruding part projecting toward said flange unit.

6. The solid-state image pickup device as set forth in claim 1, comprising:
a transparent member on a backside of said flange unit so as to cover said light-receiving unit of said solid-state image sensor.

7. The solid-state image pickup device as set forth in claim 1, comprising:
a transparent member on said solid-state image sensor so as to cover said light-receiving unit of said solid-state image sensor with a gap between said transparent member and said light-receiving unit.

8. The solid-state image pickup device as set forth in claim 1 wherein said flange unit is extended beyond said solid-state image sensor.

9. The solid-state image pickup device as set forth in claim 1 wherein said flange unit inclines toward said lens unit.

10. An electronic device comprising:
a solid-state image pickup device,
said solid-state image pickup device comprising:
a lens unit forming a subject image,
a solid-state image sensor converting into an electric signal the subject image formed by said lens unit,
a lens holder holding said lens unit inside and storing said solid-state image sensor inside, wherein:
an outside surface of said lens unit and an inside surface of said lens holder contact with each other in such a manner that said lens unit is movable along the inside surface of said lens holder, and
said lens unit having a flange unit at its bottom, the flange unit being extended beyond a contact portion where said lens unit and said lens holder contact with each other.
